(19) United States
(12) Patent Application Publication
(10) Pub. No.: US 2022/0366437 A1
(43) Pub. Date: Nov. 17, 2022

(54) METHOD AND SYSTEM FOR DEEP REINFORCEMENT LEARNING AND APPLICATION AT RIDE-HAILING PLATFORM

(71) Applicant: Beijing DiDi Infinity Technology and Development Co., Ltd., Beijing (CN)

(72) Inventors: Qingyang LI, Sunnyvale, CA (US); Tao HUANG, San Jose, CA (US); Wenjie SHANG, Beijing (CN); Zhiwei QIN, San Jose, CA (US)

(21) Appl. No.: 17/242,089

(22) Filed: Apr. 27, 2021

(51) Int. Cl. G06Q 30/02; G06Q 50/30; G06N 3/08

(52) U.S. Cl. CPC G06Q 30/0202; G06Q 50/30; G06N 3/08

(57) ABSTRACT

A computer-implemented method for machine learning and application includes training a machine learning model with training data comprising a plurality of historical transitions of a plurality of historical users at an online platform to obtain a deep Reinforcement Learning (RL) model; training a cost model with the plurality of historical transitions; obtaining a computing request related to a plurality of visiting users visiting the online platform; determining, by feeding the computing request to the deep RL model and the cost model, an incentive action for each of the visiting users; and transmitting a return signal comprising the corresponding incentive action to each of the visiting users.

### TECHNICAL FIELD

The specification generally relates to methods and systems for deep reinforcement learning and application at a ride-hailing platform.

### BACKGROUND

Online ride-hailing platforms frequently provide various resources, such as incentives, to their service providers (i.e., drivers) to encourage their participation. However, conventional computing techniques for distributing the resources fail to adequately account for varying circumstances of the drivers and passengers, which may substantially affect the demand and supply of the services provided by the ride-hailing platforms. As a result, conventional computing techniques often do not provide satisfying returns. For example, conventional computing techniques lack an efficient and accurate method to cluster and process driver information according to their unique characteristics, such as their willingness and capabilities to complete orders, and it is practically impossible for human minds to complete these tasks due to the large amount of data involved and the timeliness requirements. Therefore, an intelligent and adaptive computing technique for distributing the resources for optimized return is desirable.

### SUMMARY

In view of the foregoing limitations of existing techniques, this specification provides methods and systems for deep reinforcement learning and application at a ride-hailing platform.

One aspect of this specification is directed to a computer-implemented method for machine learning and application. The method may be applicable to an online platform.

The method may include training, by one or more computer devices, a machine learning model with training data to obtain a deep Reinforcement Learning (RL) value model. The training data may include a plurality of historical transitions at an online platform. Each of the historical transitions may correspond to: (i) a transition of a historical state of one of a plurality of historical users of the online platform from a first historical state to a second historical second, the first historical state and the second historical state respectively being the historical state of the historical user in a first time span and a second time span within a training period, and (ii) one of a plurality of incentive actions taken by the online platform.

The method may further include: training, by the one or more computer devices, a cost model with the plurality of historical transitions of the online platform, wherein the cost model reflects costs to the online platform corresponding to the plurality of incentive actions; obtaining, by the one or more computer devices, a computing request related to a plurality of visiting users visiting the online platform; determining, by the one or more computer devices, a plurality of current states respectively corresponding to the plurality of visiting users; determining, by feeding the current states respectively to the deep RL value model and the cost model, an incentive action for each of the visiting users based on outputs of the deep RL value model and the cost model; and transmitting, by the one or more computer devices, a return signal to a computer device of each of the visiting users, the return signal comprising the incentive action to the corresponding visiting user.

In some embodiments, the training period may include a plurality of training time spans each having a same length. The first time span and the second time span may be two adjacent training time spans of the plurality of training time spans.

In some embodiments, the deep RL value model may include a plurality of weights associated with the historical states and the plurality of incentive actions. And training the deep RL value model may include: assigning an initial value to each of the weights; and adjusting, based on the historical transitions, the plurality of weights. The adjusted plurality of weights may cause an accumulated return of each of the historical users to the online platform over the training period to increase.

In some embodiments, determining an incentive action for each of the visiting users may include: generating, by feeding the current states to the deep RL value model, a value matrix based on the plurality of weights, wherein the value matrix has a plurality of value coefficients each associated with a combination of one of the visiting users and one of the incentive actions; generating, by feeding the current states to the cost model, a cost matrix having a plurality of cost coefficients each associated with a combination of one of the visiting users and one of the incentive actions; and determining, based on the driver value matrix and the cost matrix, the incentive action for each of the visiting users.

In some embodiments, the total cost of all the incentive actions determined for the plurality of visiting users may be less than a predetermined limit.

In some embodiments, the online platform may be a ride-hailing platform, the visiting users may be drivers of the ride-hailing platform, and each of the training time spans may be one day.

In some embodiments, the training period may be from the first day to the thirtieth day of a corresponding user using the online platform.

In some embodiments, the accumulated return is one of the following: a total order amount, a total gross merchandise volume (GMV), and a total gross profit.

In some embodiments, the current state of each of the visiting users includes one or more of: a daily working hour, the number of daily completed orders, an average daily order duration, an average daily order distance, weather information, and temporal information.

Another aspect of this specification is directed to a device. The device may include a processor and a non-transitory computer-readable storage medium configured with instructions executable by the processor. Upon being executed by the processor, the instructions may cause the processor to perform the computer-implemented method for machine learning and application in any one of the method embodiments.

Another aspect of this specification is directed to a non-transitory computer-readable storage medium. The storage medium may be configured with instructions executable by a processor. Upon being executed by the processor, the instructions may cause the processor to perform the computer-implemented method for machine learning and application in any one of the method embodiments.

The computer-implemented methods may be used for determining the distribution of incentive actions for users of an online platform. In the methods herein disclosed, the deep RL value model may be trained with training data comprising a plurality of historical transitions at the online platform, with the historical transitions associated with a plurality of historical users. The trained deep RL value model may cause the accumulated return from the historical users to reach the largest value over a training period. Then, the trained deep RL value model is used to, along with a cost model, determine the distribution of incentive actions to visiting users. The methods determine the incentive action based on a deep reinforcement learning model tailored for each individual driver, thereby improving the distribution efficiency.

### BRIEF DESCRIPTION OF THE DRAWINGS

Preferred and non-limiting embodiments of the invention may be more readily understood by referring to the accompanying drawings.

FIG. 1 illustrates an exemplary system for machine learning and application, in accordance with various embodiments.

FIG. 2 illustrates a flow chart of a computer-implemented method for machine learning and application, in accordance with various embodiments of the specification.

FIG. 3 illustrates a block diagram illustrating a computer model in a computer-implemented method for machine learning and application, in accordance with various embodiments of this specification.

FIG. 4 illustrates a flow chart of an offline Q-learning algorithm with experience replay in accordance with various embodiments of the specification.

FIG. 5 illustrates diagrams showing the distributions of the incentive actions in two cities using a generated policy, in accordance with various embodiments of this specification.

FIG. 6 illustrates a block diagram of a computer system in accordance with various embodiments of the specification.

FIG. 7 illustrates a block diagram of a computer system in which any of the embodiments described herein may be implemented.

### DETAILED DESCRIPTION

Specific, non-limiting embodiments of the present invention will now be described with reference to the drawings. States and aspects of any embodiment disclosed herein may be used and/or combined with the states and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope, and contemplation of the present invention as further defined in the appended claims.

Active and consistent participation of the service providers is imperative to the smooth operation of online platforms (such as online ride-hailing platforms). Therefore, online platforms frequently provide various resources, such as incentives, to their service providers to retain and encourage their service. However, conventional computing techniques for distributing the resources fail to adequately account for varying circumstances of the drivers and passengers, which may substantially affect the demand and supply of the services provided by the ride-hailing platforms. For example, conventional computing techniques lack an efficient and accurate method to cluster and process user information according to their unique characteristics, and it is practically impossible for human minds to complete these tasks due to the large amount of data involved and the timeliness requirements. As a result, conventional computing techniques often do not provide satisfying returns to online platforms.

In view of the above limitations, this specification presents a computer-implemented method for machine learning and application, which determines the distribution of the resources (e.g., incentive actions) based on a deep reinforcement learning model tailored for each individual user, thereby improving the distribution efficiency.

An online platform may refer to an online service agency providing a service conducted by a service provider to a service requester. An incentive action may refer to an action taken by the online platform that rewards one or more users of the platform for taking a certain action. An incentive action (α) to a user may include distributing a tangible object and/or an intangible object to a user. For example, an incentive action may include distributing a physical and/or a digital coupon to a user. A user may refer to a person or a group of persons using the service of the platform.

For ease of description and without loss of the generality, an online ride-hailing platform is used as an exemplary online platform, drivers of the online ride-hailing platform are used as exemplary users, and coupons that award certain bonuses based on the orders completed are used as exemplary incentive actions. Other platforms, other types of users, and other forms of incentive actions are contemplated, and this specification is not limited in these regards.

An online ride-hailing platform may refer to a platform that, via websites or mobile applications (Apps.), connects vehicles or vehicle drivers offering transportation services (i.e., service supplies) with users looking for rides (i.e., service requests). In various embodiments, a user may log into a mobile APP or a website of the online ride-hailing platform and submit a request for transportation service. For example, a user may enter the starting and ending locations of a transportation trip to receive an estimated price with or without an incentive such as a discount. After receiving the estimated price (with or without a discount), the user may accept or reject the order. If the order is accepted and submitted, the online ride-hailing platform may match a vehicle with the submitted order.

The available drivers offering transportation services (i.e., service supplies) and the users requesting services (i.e., service requests) may vary substantially depending on the circumstances. For example, a driver's capability to complete orders (evaluated by the number of daily completed orders) may vary depending on how long the driver has been using the ride-hailing platform, and the number of service requests received by the ride-hailing platform may vary substantially across different months of a year and across different times of a day. Other conditions, such as geographic locations (e.g., the city the service is provided) may also affect the service demands and supplies.

To ensure adequate service demand, a ride-hailing platform will frequently provide incentives to its drivers to maintain enough service supplies. The computer-implemented methods disclosed herein use artificial intelligence, machine learning, and big data analysis and mining technologies to provide a driver target-based incentive distribution scheme that can accurately and effectively screen out different incentive actions and respond timely to fluctuating service demand.

In some embodiments, the driver target-based incentive distribution scheme disclosed herein may focus on optimizing strategies to maximize a long-term value of a driver of the ride-hailing platform. The long-term value of a driver is largely determined by the monetary value the driver generated (e.g., the revenue the driver generated) to the ride-hailing platform over a predetermined time.

Conventional strategies aimed at optimizing the selection of incentive action based on a driver's existing state. However, they do not take into consideration the influence of the incentive action on the future state of the driver. Thus, the conventional strategies for incentive action distribution are inaccurate in that they do not account for the long-term impact.

To address the issues discussed above, in some embodiments, a sequence of driver states may be formularized as a Markov Decision Process (MDP) trajectory, and the systems and methods disclosed herein may generate an optimized policy model by optimizing the long-term value of a driver using a deep reinforcement learning algorithm. The optimized policy model may be applied in real-time to the ride-hailing platform to generate an incentive action distribution scheme for the drivers.

An accumulated return from the driver is used as an exemplary criterion to evaluate the long-term value of a driver. This specification, however, does not intend to be limiting in this regard, and other criteria can be used according to specific needs.

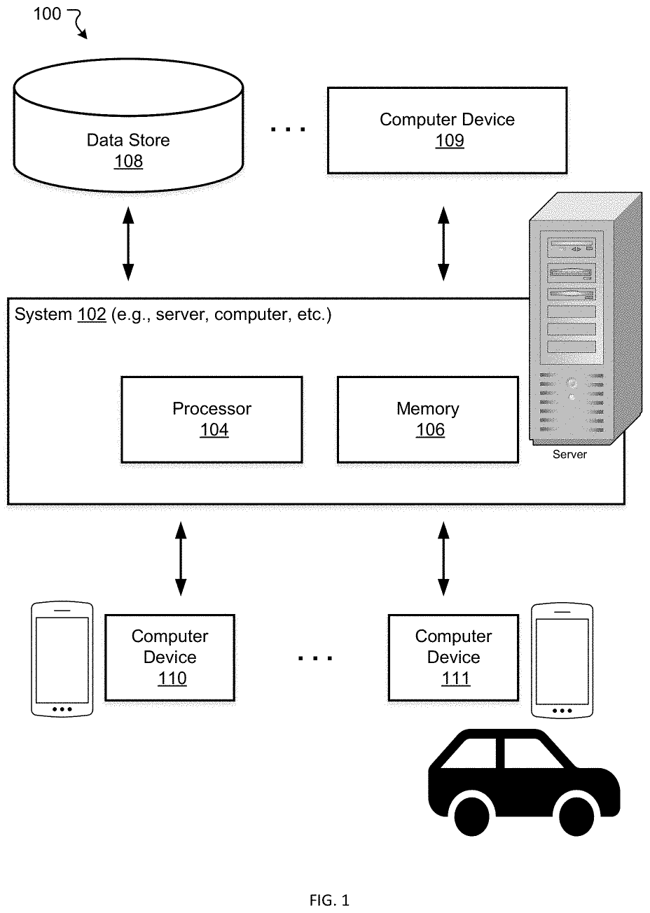

FIG. 1 illustrates an exemplary system 100 for machine learning and application, in accordance with various embodiments. The operations shown in FIG. 1 and presented below are intended to be illustrative.

As shown in FIG. 1, the exemplary system 100 may comprise at least one computing system 102 that includes one or more processors 104 and one or more memories 106. The memory 106 may be non-transitory and computer-readable. The memory 106 may store instructions that, when executed by the one or more processors 104, cause the one or more processors 104 to perform various operations described herein. The system 102 may be implemented on various devices such as mobile phones, tablets, servers, computers, wearable devices (smartwatches), etc. The system 102 may be installed with appropriate software (e.g., platform program, etc.) and/or hardware (e.g., wires, wireless connections, etc.) to access other devices of the system 100.

The system 100 may include one or more data stores (e.g., a data store 108) and one or more computer devices (e.g., a computer device 109) that are accessible to the system 102. In some embodiments, the system 102 may be configured to obtain data (e.g., historical ride-hailing data such as location, time, and fees for multiple historical vehicle transportation trips) from the data store 108 (e.g., a database or dataset of historical transportation trips) and/or the computer device 109 (e.g., a computer, a server, or a mobile phone used by a driver or passenger that captures transportation trip information such as time, location, and fees). The system 102 may use the obtained data to train a machine learning model described herein. The location may be transmitted in the form of GPS (Global Positioning System) coordinates or other types of positioning signals. For example, a computer device (e.g., computer device 109 or 111) with GPS capability and installed on or otherwise disposed of in a vehicle may transmit such location signal to another computer device (e.g., the system 102).

The system 100 may further include one or more computer devices (e.g., computer devices 110 and 111) coupled to the system 102. The computer devices 110 and 111 may include devices such as cellphones, tablets, in-vehicle computers, wearable devices (smartwatches), etc. The computer devices 110 and 111 may transmit signals (e.g., data signals) to or receive signals from the system 102.

In some embodiments, the system 102 may implement an online information or service platform. The service may be associated with vehicles (e.g., cars, bikes, boats, airplanes, etc.), and the platform may be referred to as a vehicle platform (alternatively as service hailing, ride-hailing, or ride order dispatching platform). The platform may accept requests for transportation service, identifying vehicles to fulfill the requests, arranging passenger pick-ups, and process transactions. For example, a user may use the computer device 110 (e.g., a mobile phone installed with a software application associated with the platform) to request a transportation trip arranged by the platform. The system 102 may receive the request and relay it to one or more computer device 111 (e.g., by posting the request to a software application installed on mobile phones carried by vehicle drivers or installed on in-vehicle computers). Each vehicle driver may use the computer device 111 to accept the posted transportation request and obtain pick-up location information. Fees (e.g., transportation fees) may be transacted among the system 102 and the computer devices 110 and 111 to collect trip payment and disburse driver income. Some platform data may be stored in the memory 106 or retrievable from the data store 108 and/or the computer devices 109, 110, and 111. For example, for each trip, the location of the origin and destination (e.g., transmitted by the computer device 110), the fee, and the time may be collected by the system 102.

In some embodiments, the system 102 and the one or more of the computer devices (e.g., the computer device 109) may be integrated in a single device or system. Alternatively, the system 102 and the one or more computer devices may operate as separate devices. The data store(s) may be anywhere accessible to the system 102, for example, in the memory 106, in the computer device 109, in another device (e.g., network storage device) coupled to the system 102, or another storage location (e.g., cloud-based storage system, network file system, etc.), etc. Although the system 102 and the computer device 109 are shown as single components in this figure, it is appreciated that the system 102 and the computer device 109 can be implemented as a single device or multiple devices coupled together. The system 102 may be implemented as a single system or multiple systems coupled to each other. In general, the system 102, the computer device 109, the data store 108, and the computer device 110 and 111 may be able to communicate with one another through one or more wired or wireless networks (e.g., the Internet) through which data can be communicated.

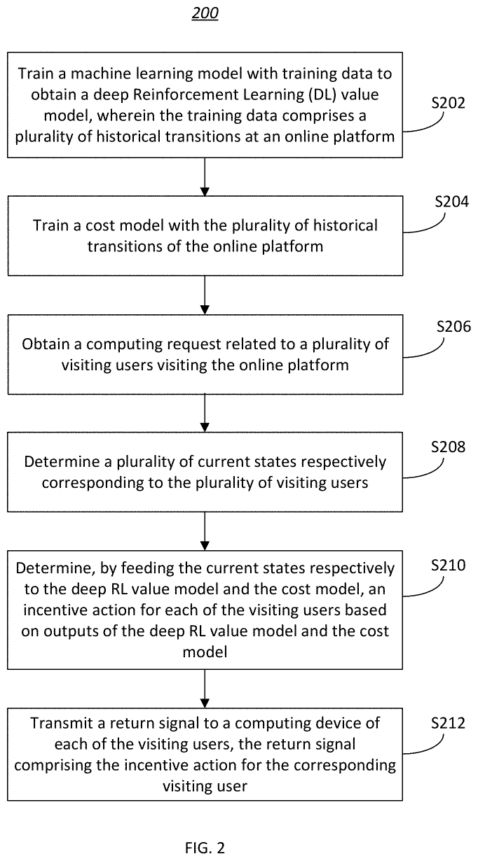

FIG. 2 illustrates a flow chart of a computer-implemented method 200 for machine learning and application in accordance with various embodiments of this specification. Referring to FIG. 2, the computer-implemented method 200 may include steps S202 through S212. In some embodiments, an exemplary system setup for the computer-implemented method 200 may be system 100 shown in FIG. 1. Each of the steps S202 through S212 in method 200 may be performed by one or more computer devices in the system 100 (e.g., computer device 109).

In step S202, the one or more computer devices may train a machine learning model with training data to obtain a deep Reinforcement Learning (RL) value model. In some embodiments, the one or more computer devices may be the computer device 109 in the system 100, as shown in FIG. 1.

The training data may include a plurality of historical transitions at an online platform. Each of the historical transitions may correspond to a transition of a historical state of one of a plurality of historical users of the online platform from an original historical state to a transited historical state. Each of the historical transitions may also correspond to one of a plurality of incentive actions taken by the online platform during the transition.

The original historical state and the transited state in a historical transition may be referred to as the “first historical state” and the “second historical state,” respectively. Each historical state may have an associated time span. The time spans associated with the original historical state (i.e., the first historical state) and the transited historical state (i.e., the second historical state) may be referred to as the “first time span” and the “second time span,” respectively.

The training period may include a plurality of training time spans each having the same length. The first time span and the second time span may be two adjacent training time spans in the training period. Historical transitions may reflect the transitions at different times in the training period. Thus, two first time spans on two historical transitions may be two different training time spans in the training period, and two second time spans in two historical transitions may be two different training time spans in the training period.

In some embodiments, a historical transition may be represented by eᵢ=(sᵢ, αᵢ, rᵢ, sᵢ₊₁), wherein sᵢ and sᵢ₊₁ represent, respectively, the first historical state and the second historical state, with the subscripts i and i+1 representing, respectively, the indices of the first time span and the second time span in the training period. αᵢ represents the incentive action taken by the online platform associated with the transition, and rᵢ represents a return to the online associated with the transition.

In some embodiments, each of the training time spans may be one day, and the training period may start from the first day a driver using the online platform, and end on, for example, the thirtieth day the driver using the platform. In one example, a driver's historical transition from day 1 to day 2 may be represented by e₁=(s₁, α₁, r₁, s₂), with s₁ and s₂ representing the driver's states at day 1 and day 2, respectively, α₁ representing the incentive action the online platform provided to the driver at day 1, and r₁ representing the driver's return to the online platform at day 1.

In some embodiments, the length of each of the training time spans and the length of the overall training period may be determined according to the specific needs and are not limited in this specification. In some embodiments, the length of the training time span may be larger than one day (e.g., one week, one month, etc.) or less than one day (e.g., one hour).

A driver's state sᵢ may include attributes, characteristics, statistics, and/or other features of the driver at the i-th time span in the training period. The state sᵢ of a driver may include static information (i.e., information that generally does not change with time) and dynamic information (information that may change with time) of the driver.

In some embodiments, the static information may include identity information (e.g., user's name, ID number, registered city, etc.) and vehicle information (e.g., vehicle's registration number, type, model, etc.) of the driver.

In some embodiments, the dynamic information may include weather information (e.g., whether it was raining or snowing) and temporal information (e.g., the time of a day or the date of a week) on the associated time span, traffic conditions, demand conditions (e.g., number of orders received), supply conditions (e.g., number of available service providers), performance information, and coupon usage information over the associated time span.

In some embodiments, the performance information may include one or more of: the working hour, the number of completed orders, an average order duration, and an average order distance. The coupon usage information may include one or more of: the number of coupons provided to the user, the number of coupons used, and the total amount of bonus received from the coupons.

Other types of state are contemplated, and this specification is not limited in this regard.

A coupon sent by the ride-hailing platform to a driver of the platform is used as an exemplary incentive action αᵢ. Different types of coupons may be used as an incentive action. For example, the coupon may be a fix-amount coupon for completing an order (e.g., a coupon of $3 for completing an order), a conditional coupon that awards a bonus for completing a certain number of orders (e.g., a coupon of $3 for completing 30 orders (α=(30, 3))), or a tiered coupon that awards different amounts of bonus based on different numbers of orders completed (e.g., a coupon of $12 for completing 30 order and additional $4 and $5 for completing 35 and 40 orders, respectively (α=[(30, 12), (35, 4), (40, 5)])). Generally, a tiered coupon may be expressed as: α=[(x₁, y₁), (x₂, y₂), . . . , (xₙ, yₙ)], wherein xᵢ represents threshold order number for each level of bonus. y₁ represents the bonus for completing x₁ orders, and yᵢ, i=2, . . . , n each represent the additional bonus over the last bonus for completing xᵢ orders.

A return rᵢ of the online platform from a driver may be the contribution the driver made to the business performance of the online platform during the i-th time span of the training period.

In some embodiments, a return rᵢ may be one of: the number of completed orders, the total Gross Merchandise Volume (GMV), and the total gross profit over the i-th time span of the training period. The number of completed orders may refer to the total number of ride-hailing orders completed by the driver. The total GMV may refer to a total monetary sale value. The total gross profit may refer to the profit the ride-hailing platform makes from the driver after deducting the cost associated with the selling of its service. Other types of returns are contemplated, and this specification is not limited in this regard.

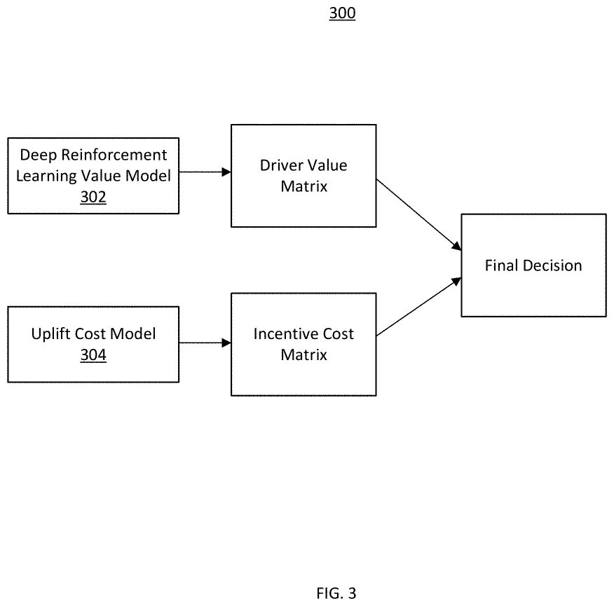

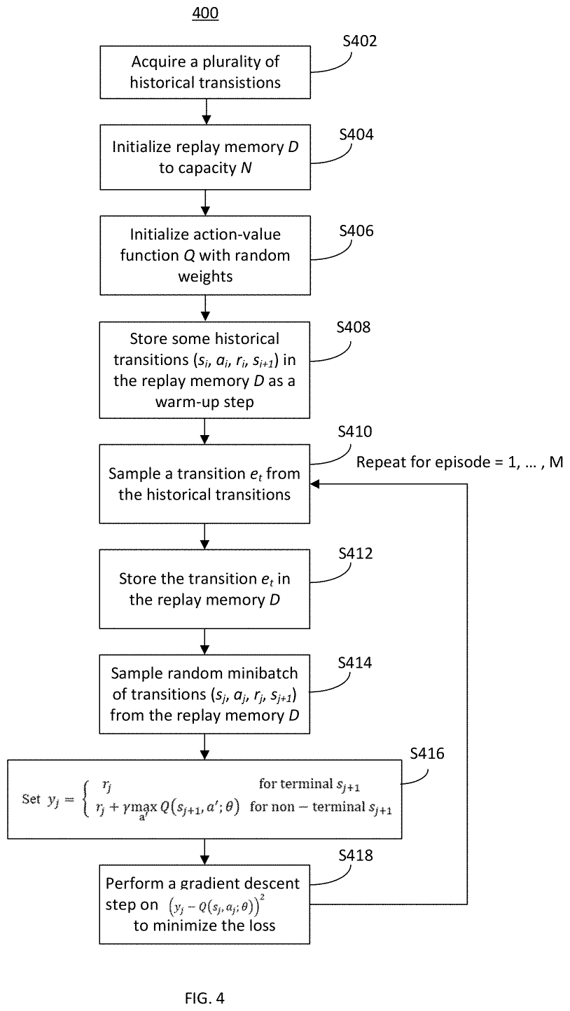

The deep Reinforcement Learning (RL) value model may be obtained by training using the plurality of historical transitions. Details of the training process will be described in a later section of this specification with reference to FIGS. 3 and 4.

Referring to FIG. 2, in step S204, the one or more computer devices may train a cost model with the plurality of historical transitions of the online platform. The cost model may reflect costs to the online platform corresponding to the incentive actions. Details of the training process will be described in a later section of this specification.

In step S206, after the deep RL value model and the cost model have been trained, the one or more computer devices may obtain a computing request related to a plurality of visiting users visiting the online platform.

In some embodiments, the visiting users may be a group of drivers of the ride-hailing platform selected according to a predetermined condition. For example, the visiting users may be all the drivers of the ride-hailing platform within a selected city. The computing request may include the state information of the plurality of visiting users. In some embodiments, the computing request may be created by the one or more computer devices based on the driver information of the ride-hailing platform. In some other embodiments, the computing may be created by an external entity that possesses the driver information of the ride-hailing platform.

In some embodiments, the computing request may be received and processed in real-time on an as-needed basis. In some embodiments, the computing request may be received and processed in a fixed interval (e.g., one computing request per day). This specification is not limited in this regard.

In step S208, the one or more computer devices may determine a plurality of current states respectively corresponding to the plurality of visiting users. The current state of a visiting user may refer to the state of the visiting user at a specific time and may be obtained from the state information of the visiting user. Each of the current states may be associated with a time span, and the length of the time span may be the same as the length of the time span of the historical transitions.

In some embodiments, the current state of a visiting user may include the same entries as the state of the historical transitions used to train the deep RL value model and the cost model. That is, the current state of each of the visiting users may include one or more of: a daily working hour, the number of daily completed orders, the average daily order duration, the average daily order distance, the weather information, and the temporal information. For example, if the state in the historical transitions includes the daily working hour, the number of completed orders, and the average order duration of the historical users, the current state of a visiting user may include the daily working hour, the number of completed orders, and the average order duration of the visiting user. In one example, the current state of a visiting user may be the latest available state of the visiting user (e.g., yesterday's state of the visiting user).

In step S210, the one or more computer devices may determine an incentive action for each of the visiting users by feeding the current states respectively to the deep RL value model 302 and the cost model 304. The incentive actions may be determined based on outputs of the deep RL value model and the cost model.

In some embodiments, step S210 may include: generating, by feeding the current states to the deep RL value model 302, a value matrix V(·) based on the plurality of weights, wherein the value matrix V(·) has a plurality of value coefficients each associated with a combination of one of the visiting users and one of the incentive actions; generating, by feeding the current states to the cost model, a cost matrix U(·) having a plurality of cost coefficients each associated with a combination of one of the visiting users and one of the incentive actions; and determining, based on the driver value matrix V(·) and the cost matrix U(·), the incentive action for each of the visiting users.

In some embodiments, Integer Programming may be used to determine an incentive action based on the driver value matrix and the incentive cost matrix. Other computing algorithms are contemplated, and this specification is not limited in this regard.

In some embodiments, the incentive action to be provided to a user may be determined under a budget constraint. For example, the total cost of all the incentive actions provided to the visiting users in a day may be no more than a daily budget.

Taken into consideration of the budget constraint, the policy may be generated based on the value matrix and the cost matrix using the following formulas:

max Σ^{m}ᵢ₌₀Σⁿⱼ₌₀V(sᵢ, αⱼ)*X(sᵢ, αⱼ)

s. t. Σ^{m}ᵢ₌₀Σⁿⱼ₌₀U(sᵢ, αⱼ)*X(sᵢ, αⱼ)≤B

s. t. Σⁿⱼ₌₀X(sᵢ, αⱼ)=1 ∀i and X(sᵢ, αⱼ)∈(0,1),

wherein V(·) is the value matrix, with each element V(sᵢ, αⱼ) representing the value to the online platform associated with a combination of a state sᵢ and an incentive action αⱼ. U(·) is the cost matrix, with each element U (sᵢ, αⱼ) representing the cost to the online platform associated with a state sᵢ and an incentive action αⱼ. B is the daily budget of the online platform. and X(sᵢ, αⱼ) represents the final decision associated with a combination of a state sᵢ and an incentive action αⱼ. Each of X(sᵢ, αⱼ) has a value of either 1 or 0, with 1 representing the j-th incentive action αⱼ will be provided to a driver with the state sᵢ. In some embodiments, one and only one incentive action will be provided for each state sᵢ.

In step S212, after the incentive action for each of the visiting users is determined, the one or more computer devices may transmit a return signal to a computer device (e.g., smartphone) of each of the visiting users. The computer device of each of the visiting users may be the computer device 111, as shown in FIG. 1. The return signal to each visiting user may include the incentive action for this visiting user. In one example, the return signal may be in a form of a message sent to the smartphone of the visiting users. The return signal may be in other forms that can deliver the incentive action to the visiting users, and this specification is not limited in this regard.

FIG. 3 illustrates a block diagram illustrating a computer model in a computer-implemented method for machine learning and application, in accordance with various embodiments of this specification. Details of the computer model and the training of the computer model will be described below with reference to FIG. 3.

Referring to FIG. 3, the computer model 300 may include the deep RL value model 302 and the uplift cost model 304. The deep RL value model 302 may include a plurality of weights. Each of the weights may be associated with one of the historical states and one of the incentive actions. In some embodiments, each of the weights may represent a value the corresponding user will bring to the online platform when the user is provided with the corresponding incentive action. The larger the value coefficients, the higher value associated with the combination of the user and the incentive action. Thus, the deep RL value model 302 may represent an action-value function Q.

The deep RL value model 302 may be configured to accept a plurality of users of the online platform as an input and generate a value matrix according to the plurality of weights. The value matrix may have a plurality of value coefficients each associated with a combination of one of a plurality of users and one of a plurality of incentive actions provided by the online platform.

The deep RL value model 302 may be trained using the training data. The training data may be a plurality of historical transitions eᵢ=(sᵢ, αᵢ, rᵢ, sᵢ₊₁), i=1, . . . , P, with P being the total number of historical transitions.

The training of the deep RL value model 302 may be characterized as a reinforcement learning process, in which the plurality of weights of the deep RL value model 302 is adjusted based on the historical transitions.

In some embodiments, the problem solved by the reinforcement learning process may be represented as a Markov Decision Processes (MDP) quintuple (S, A, T, R, γ), where S is the state space comprising a plurality of states, and A is the incentive action space comprising a plurality of incentive actions. T:S×A [symbol] S the state transition model based on S and A. T represents a process of an RL agent taking an action at a state, with the state transiting to the next state after the action. R:S×A [symbol] is the return function based on S and A. γ is the discount factor of a cumulative return.

Each state (sᵢ) in the state space S may have an associated training time span in the training period. In the embodiments described below, for ease of description, the training time spans are each set to be one day, and the training period is set to be from the first day to the thirtieth day of the corresponding user using the online platform. Thus, the training period may include thirty consecutive training time spans. The state at the initial training time span of the training period (s₁) may be referred to as the initial state, and the state at the terminal training time span of the training period (sₙ, n is the total number of training time spans) may be referred to as the terminal state. In some embodiments, other settings of the training period and training time span may be used according to a specific need, and this specification is not limited in this regard.

The goal of reinforcement learning is to optimize a policy π: S [symbol] A to maximize the expected γ-discounted cumulative return to the online platform:

J(π)=E_{π}[Σ^{T}ₜ₌₀γ^{t}rₜ].

During the reinforcement learning process, an RL agent may be an entity that is configured to observe a state sᵢ from the environment, select an action αᵢ given by a policy π to execute in the environment, and then observe a next state sᵢ₊₁ and obtain a reward rᵢ corresponding to the state transition from sᵢ to sᵢ₊₁ with the action αᵢ until the terminal state is reached. The RL agent may be implemented as software or hardware or a combination of software and hardware, and this specification is not limited in this regard.

The goal of reinforcement learning can be expressed as: finding the optimal policy of:

π*=arg max_{π}E_{π}[Σ^{T}ₜ₌₀γ^{t}rₜ],

of which the expected cumulative return reaches the largest value.

In one example, to optimize the cumulative return for the drivers, the trajectory of the driver completing the order may be modeled as an MDP trajectory, and the driver's daily working and completion of orders may be defined as a step of the MDP trajectory.

The MDP trajectory may include the following elements:

State (sᵢ): the state of a driver associated with the i-th day in the training period.

Action (αᵢ): the incentive action the online platform provided to the driver at the i-th day of the training period. There may be N+1 discrete actions available, including N incentive actions and a non-action (i.e., providing no incentive action).

Return (rᵢ): the return the driver contributes to the online platform at the i-th day of the training period. In the description below, the GMV a driver completed in the i-th day is used as an exemplary return rᵢ. The return rᵢ for the i-th day may be expressed as a summation of the GMV from all the completed orders in that day:

r=Σ^{M}ⱼ₌₀GMVⱼ

Wherein GMVⱼ is the price of the j-th order the driver completed in the i-th day, and M is the total number of orders the driver completed in the i-th day.

State transition dynamics: each state (sᵢ) may have an associated time span, and the state (sᵢ) may transit to the next state (sᵢ₊₁) corresponding to the next time span. The state transition dynamics T may be expressed as:

T(sᵢ, αᵢ)=sᵢ₊₁

Discounted factor (γ): the discounted factor γ has a value in the range of [0, 1] and reflects the relative weight of each return rᵢ to the cumulative return based on the distance of the return rᵢ from the current time. A small γ means the returns received in more recent days are weighted higher in the cumulative return than those received in future days. In one example, the discounted factor γ may have a value of 0.9.

Since it is not practical to train the policy in the real-world environment, an offline deep Q-learning approach (Offline DQN) based on the historical transitions may be adopted to train the deep RL value model 302.

In the training process, a technique known as experience replay may be used, in which the historical transitions eₜ=(sₜ, αₜ, rₜ, sₜ₊₁) at each time span in a data-set [symbol] ={e_{1,} . . . , e_{N}} may be pooled over many episodes into a relay memory. Then, the observed transitions may replace the interaction with the environment. Thus, a reliable Q-function model trained based on the historical transitions may be obtained.

In the Q-learning process, by differentiating the loss function Lᵢ(θᵢ) with respect to the model weights (θᵢ), a gradient:

$${∇}_{{θ}_{i}} {L}_{i} ( {θ}_{i} ) = {𝔼}_{s , a ; {s}^{′} \sim ℰ} [ ( r + γ {max}_{{a}^{′}} Q ( {s}^{′} , {a}^{′} ; {θ}_{i - 1} ) - Q ( s , a ; {θ}_{i} ) ) {∇}_{{θ}_{i}} Q ( s , a ; {θ}_{i} ) ]$$

may be obtained. And the model weights (θᵢ) may be optimized using a gradient descent method. In this process, the parameters from the previous iteration θᵢ₋ᵢ may be held fixed when optimizing the loss function Lᵢ(θᵢ) in the current iteration.

In some embodiments, the offline deep Q-learning approach (Offline DQN) may follow the algorithm is provided in Algorithm 1. Details of the algorithm implementation will be described in greater detail with reference to FIG. 4 in a later section of this specification.

Algorithm 1 Offline Deep Q-learning with Experience Replay

| | |
|---|---|
| 1 | Initialize replay memory [symbol] to capacity N; |
| 2 | Initialize action-value function Q with random weights. |
| 3 | Store some historical transitions (sᵢ, aᵢ, rᵢ, sᵢ₊₁) in [symbol] as a warm-up |
| | step. |
| 4 | for episode = 1, M do |
| 5 | Randomly sample a transition eₜ = (sₜ, aₜ, rₜ, sₜ₊₁) from the |
| | historical dataset. |
| 6 | Store transition eₜ in [symbol] . |
| 7 | Sample random minibatch of transitions (sⱼ, aⱼ, rⱼ, sⱼ₊₁) from [symbol] . |
| 8 | $Set {y}_{j} = \{ \begin{matrix}{r}_{j} & for terminal {s}_{j + 1} \\ {r}_{j} + {γmax}_{{a}^{′}} Q ( {s}_{j + 1} , {a}^{′} ; θ ) & for non - terminal {s}_{j + 1}\end{matrix} .$ |
| 9 | Perform a gradient descent step on (yⱼ − Q(sⱼ, aⱼ; θ))² to |
| | minimize the loss. |
| 10 | end for |

Referring to FIG. 3, the uplift cost model 304 of the computer model 300 may be trained using the plurality of historical transitions. The trained uplift cost model 304 may predict a cost to the online platform based on a combination of a state of the user and an incentive action.

In some embodiments, the training of the uplift cost model 304 may be characterized as a process to determine a function predicting a cost to the ride-hailing platform according to a state and an incentive action, which may be expressed as:

U(sᵢ, αₜ)=cᵢ

wherein U(·) is the function to predict the cost cᵢ based on the incentive action αᵢ and the state sᵢ. The uplift cost model 304 may be trained based on the actual cost to the ride-hailing platform for each combination of the incentive action αᵢ and the state sᵢ, which can be obtained from the historical transitions. Various functions, such as the least square regression method, may be used to determine the function U(sᵢ, αᵢ), and this specification is not limited in this regard.

FIG. 4 illustrates a flow chart of the implementation of the offline deep Q-learning algorithm with experience replay in accordance with various embodiments of the specification.

As shown in FIG. 4, the Q-learning algorithm 400 may include the following steps S402 through S418.

In step S402, a plurality of historical transitions e₁=(sᵢ, αᵢ, rᵢ, sᵢ₊₁) may be acquired. The historical transitions may include transitions in each of a plurality of time spans from an initial time span to the terminal time span. If there are K time spans (i=1, . . . , K), the plurality of historical transitions may include all the transitions from e₁ to e_{K}. The definitions of the parameters in the historical transitions eᵢ are the same as those described before and are omitted herein for the sake of conciseness.

In step S404, a replay memory [symbol] may be initialized to capacity N. The capacity N may be determined based on the specific need and is not limited in this specification.

In step S406, the plurality of weights of the deep RL value model 302 may be initialized with random values. Each weight may correspond to a combination of one of the states and one of the incentive actions in the historical transitions.

In step S408, some historical transitions (sᵢ, αᵢ, rᵢ, sᵢ₊₁) may be stored in the replay memory [symbol] as a warm-up step.

In step S410, a historical transition eₜ=(sₜ, αₜ, rₜ, sₜ₊₁) may be selected from the historical transitions.

In step S412, the historical transition eₜ may be stored in the replay memory [symbol] .

In step S414, a minibatch of transitions (sⱼ, αⱼ, rⱼ, sⱼ₊₁) may be selected from the replay memory [symbol] .

In step S416, the value of γⱼ may be set according to:

$${y}_{j} = \{ \begin{matrix}{r}_{j} & if {s}_{j + 1} is the terminal state \\ {r}_{j} + γ {max}_{{a}^{′}} Q ( {s}_{j + 1} , {a}^{′} ; θ ) & if {s}_{j + 1} is a non - terminal state\end{matrix} .$$

wherein θ represents the weights in the deep RL value model 302.

In step S418, the optimized weights (θ) may be obtained by minimizing (γⱼ−Q(sⱼ, αⱼ; θ))² using, for example, a gradient descent method.

The steps S410 through S418 above may be repeatedly performed for multiple episodes (e.g., for episodes 1 to M) so that all the weights in deep RL value model 302 may be optimized.

The simulations using the foregoing training process show that a learning curve can smoothly and quickly converge to a reasonable Q value, indicating a successful learning process of the deep RL value model.

Upon completing the Q-learning algorithm described above. The optimized values of the weights of the deep RL value model 302 may be obtained.

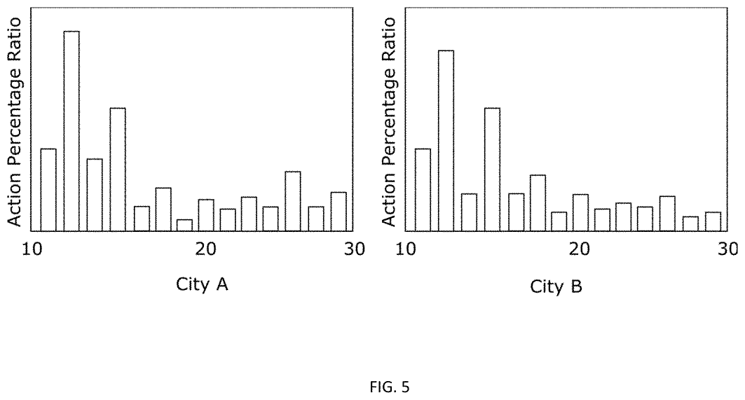

FIG. 5 illustrates diagrams showing the distributions of the incentive actions in two cities using the policy generated based on a computer-implemented method in accordance with various embodiments of this specification.

In the two diagrams shown in FIG. 5, the horizontal axes (i.e., x-axes) represent the threshold order amount for receiving the first bonus (i.e., x₁). The vertical axes (i.e., y-axes) represent the number of corresponding incentive actions being sent. As shown in FIG. 5, with the policy generated with the method of this specification, a larger portion of incentive actions sent by the online platform in both of the two cities (i.e., City A and City B) has a relatively low first threshold, which matches the real-world scenario that the majority of drivers complete a relatively small number of orders, indicating that the method disclosed herein adopted well with the distribution of actual orders.

The improved efficiency of the computer-implemented method disclosed herein (i.e., the deep RL method) is demonstrated by comparing with an existing technique (i.e., the baseline method). The deep RL method was deployed to the online system of a ride-hailing platform in six cities, and the overall Return-of-Investment (ROI) using the deep RL method is compared with that using the baseline method under the same subsidy rate. The ROI is computed by:

ROI=(GMVₜ−GMV_{c})/(Costₜ−Cost_{c}),

wherein GMVₜ and Costₜ represent, respectively, the GMV and the cost of the ride-hailing platform with one incentive distribution scheme (i.e., either the deep RL method or the baseline method) being applied, and GMV_{c} and Cost_{c} represent, respectively, the GMV and the cost of the ride-hailing platform of a control group with no incentive distribution scheme being applied.

The comparison results are listed in Table 1 below.

TABLE 1
The comparison results of using the deep RL
method and a baseline method

| Method | Overall ROI |
|---|---|
| Deep RL method | 2.097 |
| Baseline method | 2.064 |

As shown in Table 1, the deep RL method provides a higher overall ROI than the baseline method, indicating the deep RL method's effectiveness and the importance of optimizing long-term value for drivers.

In the methods herein disclosed, the deep RL value model may be trained with training data comprising a plurality of historical transitions at the online platform. The trained deep RL value model may cause the accumulated return from the historical users to reach the largest value over a training period. Then, the trained deep RL value model is used to, along with a cost model, determine the distribution of incentive actions to visiting users. The methods determine the incentive action based on a deep reinforcement learning model tailored for each individual driver, thereby improving the distribution efficiency.

Based on the method embodiments, this specification further presents a computer device. The computer device may include a processor coupled with a non-transitory computer-readable storage medium. The storage medium may store instructions executable by the processor. Upon being executed by the processor, the instructions may cause the processor to perform any one of the computer-implemented methods for machine learning and application, as described in the method embodiments.

Based on the system and method embodiments, this specification further presents a non-transitory computer-readable storage medium. The storage medium may store instructions executable by a processor. Upon being executed by a processor, the instructions may cause the processor to perform any one of the computer-implemented methods for machine learning and application, as described in the method embodiments.

This specification further presents a computer system for implementing the method for machine learning and application, in accordance with various embodiments of this specification.

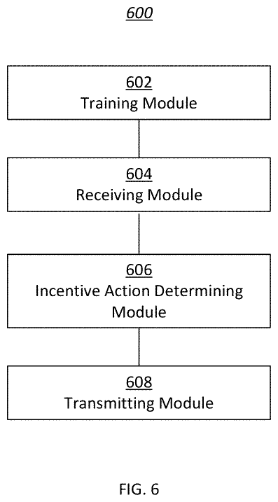

FIG. 6 illustrates a block diagram of a computer system 600 for machine learning and application, in accordance with various embodiments of this specification. The computer system 600 may be an exemplary entity performing method 200 of FIG. 2.

The computer system 600 may include one or more processors and one or more non-transitory computer-readable storage media (e.g., one or more memories) coupled to the one or more processors and configured with instructions executable by the one or more processors to cause the system or device (e.g., the processor) to perform the method 200. The computer system 600 may include various units/modules corresponding to the instructions (e.g., software instructions). In some embodiments, the instructions may correspond to a software such as a desktop software or an application (APP) installed on a mobile phone, pad, etc.

In some embodiments, the computer system 600 may include a training module 602, a receiving module 604, an incentive action determining module 606, and a transmitting module 608.

The training module 602 may be configured to train a machine learning model with training data to obtain a deep Reinforcement Learning (RL) value model.

The training data may include a plurality of historical transitions at an online platform each corresponding to: (i) a transition of a historical state of one of a plurality of historical users of the online platform from a first historical state to a second historical state, the first historical state and the second historical state respectively being the historical state of the historical user in a first time span and a second time span within a training period, and (ii) one of a plurality of incentive actions taken by the online platform.

The training module 602 may be further configured to train a cost model with the plurality of historical transitions of the online platform. The cost model may reflect costs to the online platform corresponding to the plurality of incentive actions.

The receiving module 604 may be configured to obtain a computing request related to a plurality of visiting users visiting the online platform.

The incentive action determining module 606 may be configured to determine a plurality of current states respectively corresponding to the plurality of visiting users; and determine, by feeding the current states respectively to the deep RL value model and the cost model, an incentive action for each of the visiting users based on outputs of the deep RL value model and the cost model.

The transmitting module 608 may be configured to transmit a return signal to a computer device of each of the visiting users, the return signal comprising the incentive action for the corresponding visiting user.

This specification further presents another computer system for implementing the method for determining incentive action distribution in accordance with various embodiments of this specification.

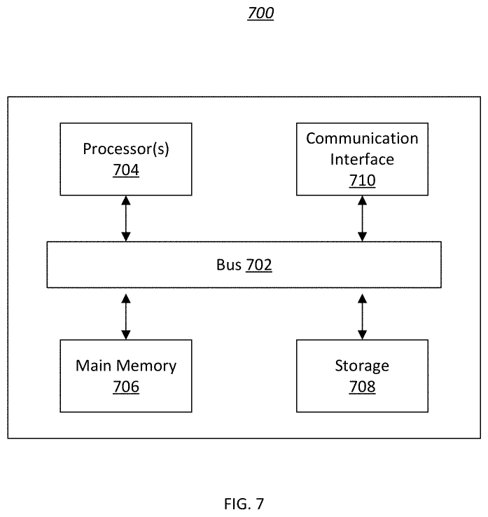

FIG. 7 is a block diagram that illustrates a computer system 700 upon which any of the embodiments described herein may be implemented. The computer system 700 includes a bus 702 or other communication mechanisms for communicating information, one or more hardware processors 704 coupled with bus 702 for processing information. Hardware processor(s) 704 may be, for example, one or more general-purpose microprocessors.

The computer system 700 also includes a main memory 706, such as a random-access memory (RAM), cache, and/or other dynamic storage devices, coupled to bus 702 for storing information and instructions to be executed by processor(s) 704. Main memory 706 also may be used for storing temporary variables or other intermediate information during the execution of instructions to be executed by processor(s) 704. Such instructions, when stored in storage media accessible to processor(s) 704, render computer system 700 into a special-purpose machine that is customized to perform the operations specified in the instructions. Main memory 706 may include non-volatile media and/or volatile media. Non-volatile media may include, for example, optical or magnetic disks. Volatile media may include dynamic memory. Common forms of media may include, for example, a floppy disk, a flexible disk, hard disk, solid-state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 700 may implement the techniques described herein using customized hard-wired logic, one or more ASICs or FPGAs, firmware and/or program logic, which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 708. Execution of the sequences of instructions contained in main memory 706 causes processor(s) 704 to perform the method steps described herein. For example, the method steps shown in FIGS. 2 and 4 and described in connection with these drawings can be implemented by computer program instructions stored in main memory 706. When these instructions are executed by processor(s) 704, they may perform the steps as shown in FIGS. 2 and 4 and described above. In alternative embodiments, hard-wired circuitry may be used in place of or in combination with software instructions.

The computer system 700 may also include a communication interface 710 coupled to bus 702. Communication interface 710 may provide a two-way data communication coupling to one or more network links that are connected to one or more networks. As another example, communication interface 710 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across multiple machines. In some embodiments, the processors or processor-implemented engines may be in a single geographic location (e.g., within a home environment, an office environment, or a server farm). In other embodiments, the processors or processor-implemented engines may be distributed across multiple geographic locations.

Certain embodiments are described herein as including logic or multiple components. Components may constitute either software components (e.g., code embodied on a machine-readable medium) or hardware components (e.g., a tangible unit capable of performing certain operations which may be configured or arranged in a certain physical manner).

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

What is claimed is:

1. A computer-implemented method for machine learning and application, the method comprising:
training, by one or more computer devices, a machine learning model with training data to obtain a deep Reinforcement Learning (RL) value model, wherein the training data comprises a plurality of historical transitions at an online platform each corresponding to:
(i) a transition of a historical state of one of a plurality of historical users of the online platform from a first historical state to a second historical state, the first historical state and the second historical state respectively being the historical state of the historical user in a first time span and a second time span within a training period, and
(ii) one of a plurality of incentive actions taken by the online platform;
training, by the one or more computer devices, a cost model with the plurality of historical transitions of the online platform, wherein the cost model reflects costs to the online platform corresponding to the plurality of incentive actions;
obtaining, by the one or more computer devices, a computing request related to a plurality of visiting users visiting the online platform;
determining, by the one or more computer devices, a plurality of current states respectively corresponding to the plurality of visiting users;
determining, by feeding the current states respectively to the deep RL value model and the cost model, an incentive action for each of the visiting users based on outputs of the deep RL value model and the cost model; and
transmitting, by the one or more computer devices, a return signal to a computer device of each of the visiting users, the return signal comprising the incentive action for the corresponding visiting user.

2. The method of claim 1, wherein the training period includes a plurality of training time spans each having a same length, the first time span and the second time span are two adjacent training time spans of the plurality of training time spans.

3. The method of claim 2, wherein the deep RL value model comprises a plurality of weights associated with the historical states and the plurality of incentive actions, and
wherein training the deep RL value model comprises:
assigning an initial value to each of the weights; and
adjusting, based on the historical transitions, the plurality of weights, the adjusted plurality of weights causing an accumulated return of each of the historical users to the online platform over the training period to increase.

4. The method of claim 3, wherein the determining an incentive action for each of the visiting users comprises:
generating, by feeding the current states to the deep RL value model, a value matrix based on the plurality of weights, wherein the value matrix has a plurality of value coefficients each associated with a combination of one of the visiting users and one of the incentive actions;
generating, by feeding the current states to the cost model, a cost matrix having a plurality of cost coefficients each associated with a combination of one of the visiting users and one of the incentive actions; and
determining, based on the driver value matrix and the cost matrix, the incentive action for each of the visiting users.

5. The method of claim 4, wherein a total cost of all the incentive actions determined for the plurality of visiting users is less than a predetermined limit.

6. The method of claim 4, wherein the online platform is a ride-hailing platform, the visiting users are drivers of the ride-hailing platform, and each of the training time spans is one day.

7. The method of claim 6, wherein the training period is from the first day to the thirtieth day of a corresponding user using the online platform.

8. The method of claim 6, wherein the accumulated return is one of the following:
a number of completed orders,
a total gross merchandise volume (GMV), and
a total gross profit.

9. The method of claim 6, wherein the current state of each of the visiting users includes one or more of:
a daily working hour,
a number of daily completed orders,
an average daily order duration,
an average daily order distance,
weather information, and
temporal information.

10. A device, comprising a processor and a non-transitory computer-readable storage medium configured with instructions executable by the processor, wherein, upon being executed by the processor, the instructions cause the processor to perform operations comprising:
training a machine learning model with training data to obtain a deep Reinforcement Learning (RL) value model, wherein the training data comprises a plurality of historical transitions at an online platform each corresponding to:
(i) a transition of a historical state of one of a plurality of historical users of the online platform from a first historical state to a second historical state, the first historical state and the second historical state respectively being the historical state of the historical user in a first time span and a second time span within a training period, and
(ii) one of a plurality of incentive actions taken by the online platform;
training a cost model with the plurality of historical transitions of the online platform, wherein the cost model reflects costs to the online platform corresponding to the plurality of incentive actions;
obtaining a computing request related to a plurality of visiting users visiting the online platform;
determining a plurality of current states respectively corresponding to the plurality of visiting users;
determining, by feeding the current states respectively to the deep RL value model and the cost model, an incentive action for each of the visiting users based on outputs of the deep RL value model and the cost model; and
transmitting a return signal to a computer device of each of the visiting users, the return signal comprising the incentive action for the corresponding visiting user.

11. The device of claim 10, wherein the training period includes a plurality of training time spans each having a same length, the first time span and the second time span are two adjacent training time spans of the plurality of training time spans.

12. The device of claim 11, wherein the deep RL value model comprises a plurality of weights associated with the historical states and the plurality of incentive actions, and
wherein training the deep RL value model comprises:
assigning an initial value to each of the weights; and
adjusting, based on the historical transitions, the plurality of weights, the adjusted plurality of weights causing an accumulated return of each of the historical users to the online platform over the training period to increase.

13. The device of claim 12, wherein the determining an incentive action for each of the visiting users comprises:
generating, by feeding the current states to the deep RL value model, a value matrix based on the plurality of weights, wherein the value matrix has a plurality of value coefficients each associated with a combination of one of the visiting users and one of the incentive actions;
generating, by feeding the current states to the cost model, a cost matrix having a plurality of cost coefficients each associated with a combination of one of the visiting users and one of the incentive actions; and
determining, based on the driver value matrix and the cost matrix, the incentive action for each of the visiting users.

14. The device of claim 13, wherein a total cost of all the incentive actions determined for the plurality of visiting users is less than a predetermined limit.

15. The device of claim 13, wherein the online platform is a ride-hailing platform, the visiting users are drivers of the ride-hailing platform, and each of the training time spans is one day.

16. The device of claim 15, wherein the training period is from the first day to the thirtieth day of a corresponding user using the online platform.

17. The device of claim 15, wherein the accumulated return is one of the following:
a total order amount,
a total gross merchandise volume (GMV), and
a total gross profit.

18. The device of claim 15, wherein the current state of each of the visiting users includes one or more of:
a daily working hour,
a number of daily completed orders,
an average daily order duration,
an average daily order distance,
weather information, and
temporal information.

19. A non-transitory computer-readable storage medium, configured with instructions executable by a processor, wherein upon being executed by the processor, the instructions cause the processor to perform operations comprising:
training, by one or more computer devices, a machine learning model with training data to obtain a deep Reinforcement Learning (RL) value model, wherein the training data comprises a plurality of historical transitions at an online platform each corresponding to:
(i) a transition of a historical state of one of a plurality of historical users of the online platform from a first historical state to a second historical state, the first historical state and the second historical state respectively being the historical state of the historical user in a first time span and a second time span within a training period, and
(ii) one of a plurality of incentive actions taken by the online platform;
training, by the one or more computer devices, a cost model with the plurality of historical transitions of the online platform, wherein the cost model reflects costs to the online platform corresponding to the plurality of incentive actions;
obtaining, by the one or more computer devices, a computing request related to a plurality of visiting users visiting the online platform;
determining, by the one or more computer devices, a plurality of current states respectively corresponding to the plurality of visiting users;
determining, by feeding the current states respectively to the deep RL value model and the cost model, an incentive action for each of the visiting users based on outputs of the deep RL value mode and the cost model; and
transmitting, by the one or more computer devices, a return signal to a computer device of each of the visiting users, the return signal comprising the incentive action for the corresponding visiting user.

20. The storage medium of claim 19, wherein in the computer-implemented method, the training period includes a plurality of training time spans each having a same length, the first time span and the second time span are two adjacent training time spans of the plurality of training time spans.
